(19) United States
(12) Patent Application Publication
(10) Pub. No.: US 2007/0149727 A1
(43) Pub. Date: Jun. 28, 2007

(54) Moisture-curable resin composition

(75) Inventors: Hiroyuki Okuhira, Kanagawa (JP); Kazunori Ishikawa, Kanagawa (JP); Mariko Hatanaka, Kanagawa (JP); Masaki Yamamoto, Kanagawa (JP); Hiroyuki Hosoda, Kanagawa (JP)

Correspondence Address: CONNOLLY BOVE LODGE & HUTZ LLP, P.O. BOX 2207, WILMINGTON, DE, 19899-2207, US

(73) Assignee: The Yokohama Rubber Co., Ltd., Tokyo (JP)

(21) Appl. No.: 11/642,908

(22) Filed: Dec. 21, 2006

(30) Foreign Application Priority Data
Dec. 22, 2005 (JP) 2005-370059

(51) Int. Cl. C08L 63/00

(52) U.S. Cl. 525/523

(57) ABSTRACT

The moisture-curable resin composition according to the present invention contains: an epoxy resin; and a ketimine compound having a ketimine (C═N) bond which is derived from a ketone represented by formula (1) below, 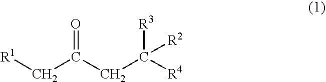
[where R¹ represents an alkyl group which has 1 to 5 carbon atoms and may have a substituent; R represents an alkyl group having 1 to 4 carbon atoms; and R³ and R⁴ each independently represent an alkyl group having 1 to 3 carbon atoms, and either of them may represent a hydrogen atom], and an amine.

### BACKGROUND OF THE INVENTION

The present invention relates to a moisture-curable resin composition containing an epoxy resin and a ketimine compound.

Various kinds of one-component type epoxy resin compositions have been known, and among others, various techniques have been disclosed for preparing a one-component type epoxy resin composition using a ketimine compound obtained from methyl isobutyl ketone (MIBK).

However, uses of the ketimine compound obtained from MIBK have caused inferior storage stabilities.

For overcoming such a disadvantage, JP 3404390 B discloses “a one-pack type moisture-curable epoxy resin composition including: a ketimine compound represented by Chemical Formula (2) which is obtained by reacting a carbonyl compound represented by Chemical Formula (1) with an amine compound having a primary amino group; and an epoxy resin. 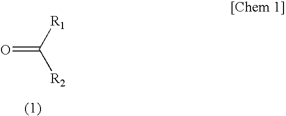
where R¹ and R² are each any alkyl group selected from the group consisting of alkyl groups having 2 to 6 carbon atoms, and R¹ and R²are the same or different alkyl groups. 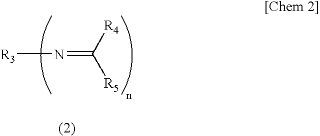
where R³ is a residue as an amine compound excluding its primary amino group; R⁴ and R⁵ are each any alkyl group selected from the group consisting of alkyl groups having 2 to 6 carbon atoms, and R⁴ and R⁵ are the same or different alkyl groups; and n is an integer of 1 or more”.

### SUMMARY OF THE INVENTION

The one-pack type epoxy resin composition described in JP 3404390 B has an excellent storage stability but, at the same time, has a short working life due to high cure rate. In other words, there is a problem of inferior workability. Further, it has been found that the storage stability of the composition is deteriorated when it is used together with a urethane prepolymer in view of an enhanced flexibility or the like.

Therefore, an object of the present invention is to provide a moisture-curable resin composition having both an excellent workability and an excellent storage stability, which retains its excellent storage stability even in combined use with a urethane prepolymer.

The inventors of the present invention have made extensive studies for solving the above-mentioned problems, and have completed the present invention by finding out that a composition containing an epoxy resin and a certain ketimine compound can be provided as a moisture-curable resin composition having both an excellent workability and an excellent storage stability.

That is, the present invention provides a moisture-curable resin composition as stated in each of the following items (i) to (vii).

(i) A moisture-curable resin composition, containing:

an epoxy resin; and

a ketimine compound having a ketimine (C═N) bond which is derived from a ketone represented by formula (1) below: 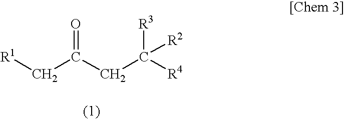
and an amine.

In the above formula, R¹ represents an alkyl group which has 1 to 5 carbon atoms and may have a substituent; R² represents an alkyl group having 1 to 4 carbon atoms; and R³ and R⁴ each independently represent an alkyl group having 1 to 3 carbon atoms, and either of them may represent a hydrogen atom.

(ii) The moisture-curable resin composition according to item (i), wherein the ketone is a ketone represented by formula (2) below:

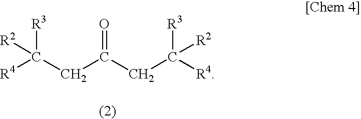

In the above formula, R² represents an alkyl group having 1 to 4 carbon atoms, with a plurality of groups R² being maybe the same or different; and R³ and R⁴ each independently represent an alkyl group having 1 to 3 carbon atoms, and either of them may represent a hydrogen atom, with a plurality of groups R³ being maybe the same or different, and a plurality of groups R⁴ being maybe the same or different.

(iii) The moisture-curable resin composition according to item (i), wherein the amine is a polyamine having at least two amino groups in a molecule.

(iv) The moisture-curable resin composition according to item (iii), wherein the polyamine is a linear polyalkylene polyamine.

(v) The moisture-curable resin composition according to item (iv), wherein the polyamine has amino groups at both ends of a linear alkylene having 3 to 6 carbon atoms.

(vi) The moisture-curable resin composition according to item (i), further comprising 1 part by weight or more but less than 100 parts by weight of a urethane prepolymer with respect to 100 parts by weight of the epoxy resin.

(vii) The moisture-curable resin composition according to item (vi), wherein the urethane prepolymer has a structure in which every isocyanate group in a molecule binds to a secondary carbon atom, or to a tertiary carbon atom other than that in an aromatic ring.

According to the present invention, the moisture-curable resin composition having both an excellent workability and an excellent storage stability and retaining its excellent storage stability even in the combined use with a urethane prepolymer can be provided, which is very useful.

### DETAILED DESCRIPTION OF THE INVENTION

Hereinafter, the present invention will be described in detail.

The moisture-curable resin composition according to the present invention (hereinafter, also referred to simply as “composition of the present invention”) is a moisture-curable resin composition which contains an epoxy resin and a ketimine compound having a ketimine (C═N) bond which is derived from a ketone represented by the above-mentioned formula (1) and an amine, and preferably further contains a urethane prepolymer in view of an enhanced flexibility.

In the following description, the epoxy resin, ketimine compound, and urethane prepolymer used in the moisture-curable resin composition of the present invention will be explained in detail.

(Epoxy Resin)

The epoxy resin used in the composition of the present invention is not particularly limited as far as it is a resin composed of a compound having two or more oxirane rings (epoxy groups) in a molecule. Typically, an epoxy resin having an epoxy equivalent of 90 to 2000 is used.

The epoxy resin as described above may be a conventional one. Specific examples thereof include: bifunctional glycidyl ether type epoxy resins such as epoxy compounds each having a bisphenyl group, including those of a bisphenol A type, a bisphenol F type, a brominated bisphenol A type, a hydrogenated bisphenol A type, a bisphenol S type, a bisphenol AF type and a biphenyl type, epoxy compounds of a polyalkylene glycol type or an alkylene glycol type, epoxy compounds each having a naphthalene ring, and epoxy compounds each having a fluorene group;

polyfunctional glycidyl ether type epoxy resins, including those of a phenol novolac type, an ortho-cresol novolac type, a DPP novolac type, a tris-hydroxyphenyl methane type, a trifunctional type, and a tetraphenylol ethane type;

epoxy resins of the type of a glycidyl ester of a synthetic fatty acid such as a dimer acid;

aromatic epoxy resins each having a glycidyl amino group, such as N,N,N′,N′-tetraglycidyldiamino diphenylmethane (TGDDM) represented by the following formula (3): 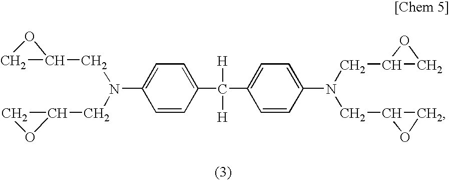
tetraglycidyl-m-xylylene diamine, triglycidyl-p-aminophenol, and N,N-diglycidyl aniline;

an epoxy compound having a tricyclo[5,2,1,0^{2, 6}]decane ring and represented by the following formula (4): 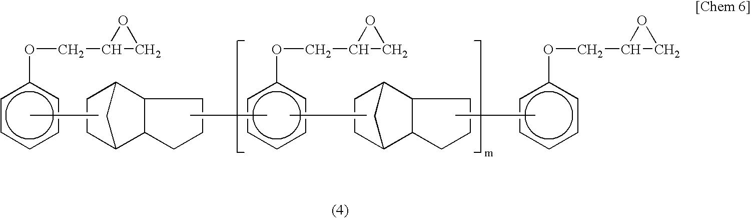
[where m represents an integer of 0 to 15], for instance, an epoxy compound which can be obtained by a known manufacturing method in which dicyclopentadiene is polymerized together with a cresol such as meta-cresol or a phenol, and the polymerized product is reacted with epichlorohydrin; as well as

an alicyclic epoxy resin; an epoxy resin having a sulfur atom on the epoxy resin main chain which is typified by FLEP-10 manufactured by Toray Fine Chemicals Co., Ltd.; a urethane-modified epoxy resin having a urethane bond; and a rubber-modified epoxy resin containing polybutadiene, liquid polyacrylonitrile-butadiene rubber, or acrylonitrile-butadiene rubber (NBR).

Such epoxy resins as above may be used alone or in combination of two or more thereof.

Among various epoxy resins as mentioned above for illustration, those which have an aromatic ring in a backbone are suitable for use because they give a moisture-curable resin composition having more favorable physical properties (e.g., tensile strength) and a better adhesion.

Usable examples of the epoxy resins as described above include commercially available products such as EP4100E manufactured by ADEKA CORPORATION, and Epicoat 828, Epicoat 807, Epicoat 806, Epicoat 154 and Epicoat 630 which are manufactured by Japan Epoxy Resins Co., Ltd.

(Ketimine Compound)

The ketimine compound used in the composition of the present invention is a ketimine compound having a ketimine (C═N) bond which is derived from a ketone represented by the formula (1) described below and-an amine.

The moisture-curable resin composition that contains a ketimine compound obtained by using the specific ketone as above has both a favorable workability and a favorable storage stability. The reason appears to be as follows: The carbon atom in the carbonyl group of the ketone has two valence arms each bound to an alkyl group of 2 to 6 carbon atoms, and either or both of the carbon atoms located in the β positions with respect to the carbonyl carbon atom are branching carbon atoms, which ensures a certain range of movement for a bulky substituent including such a branching carbon atom and smaller substituents bound to the branching carbon atom. The steric hindrance of the bulky substituent as well as its movement should make the approach of an epoxy group of the epoxy resin to a nitrogen atom of the ketimine compound difficult.

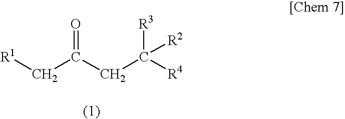

In the above formula, R¹ represents an alkyl group which has 1 to 5 carbon atoms and may have a substituent; R² represents an alkyl group having 1 to 4 carbon atoms; and R³ and R⁴ each independently represent an alkyl group having 1 to 3 carbon atoms, and either of them may represent a hydrogen atom.

Here, specific examples of the alkyl group R¹ in the formula (1), which has 1 to 5 carbon atoms and may have a substituent, include a methyl group, an ethyl group, an n-propyl group, an n-butyl group, an n-pentyl group, an isopropyl group, and a 1-methylpropyl group.

In addition, examples of the alkyl group R² having 1 to 4 carbon atoms include a methyl group, an ethyl group, an n-propyl group, and an n-butyl group.

Examples of the alkyl groups R³ and R⁴ each having 1 to 3 carbon atoms include a methyl group, an ethyl group, and an n-propyl group.

Specific examples of the ketone represented by the formula (1) include ethyl isobutyl ketone represented by the following formula (5), isobutyl propyl ketone represented by the following formula (6), and ethyl (2-methylbutyl)ketone represented by the following formula (7).

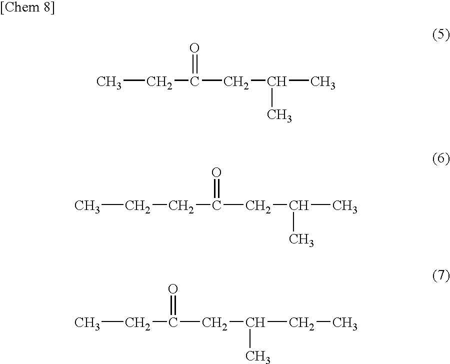

In the present invention, the ketone represented by the above-mentioned formula (1) is preferably a ketone represented by the formula (2) below because a moisture-curable resin composition containing a ketimine compound obtained from the latter ketone has more favorable workability and storage stability.

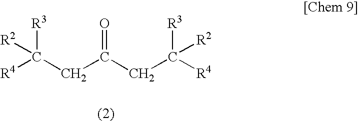

In the above formula, R² represents an alkyl group having 1 to 4 carbon atoms, with a plurality of groups R² being maybe the same or different; and R³ and R⁴ each independently represent an alkyl group having 1 to 3 carbon atoms, and either of them may represent a hydrogen atom, with a plurality of groups R³ being maybe the same or different, and a plurality of groups R⁴ being maybe the same or different.

Here, R¹, R², R³, and R⁴ in the above-mentioned formula (2) are identical with R¹, R², R³, and R⁴ in the above-mentioned formula (1), respectively.

Specifically, ketones represented by the above-mentioned formula (2) include diisobutyl ketone represented by the following formula (8).

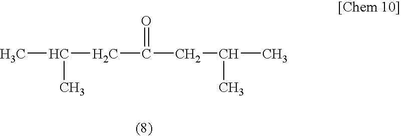

On the other hand, in the present invention, the amine used in the synthesis of the above-mentioned ketimine compound may be any amine widely known, and is preferably a polyamine having two or more amino groups in a molecule.

Specific examples of the polyamine include: aliphatic polyamines such as ethylenediamine, trimethylenediamine, tetramethylenediamine, pentamethylenediamine, diethylenetriamine, triethylenetetramine, tetraethylenepentamine, pentaethylenehexamine, hexamethylenediamine, trimethylhexamethylenediamine, 1,2-propanediamine, iminobispropylamine, methyliminobispropylamine, and 1,5-diamino-2-methylpentane (e.g., MPMD manufactured by DuPont Japan); aromatic polyamines such as meta-phenylenediamine, ortho-phenylenediamine, para-phenylenediamine, m-xylylenediamine (MXDA), diaminodiphenylmethane, diaminodiphenylsulfone, and diaminodiethyldiphenylmethane; N-aminoethylpiperazine; monoamines each having an ether linkage in its main chain such as 3-butoxyisopropylamine; diamines each having a polyether backbone which are typified by Jeffamine EDR148 manufactured by Mitsui Fine Chemicals, Inc.; alicyclic polyamines such as isophoronediamine, 1,3-bisaminomethylcyclohexane (e.g., 1,3-BAC manufactured by Mitsubishi Gas Chemical Company, Inc.), 1-cyclohexylamino-3-aminopropane, and 3-amimomethyl-3,3,5-trimethyl-cyclohexylamine; diamines each having a norbornane backbone such as norbornanediamine (e.g., NBDA manufactured by Mitsui Chemicals, Inc.); polyamideamines each having an amino group at an end of a polyamide molecule; as well as 2,5-dimethyl-2,5-hexamethylenediamine, menthenediamine, 1,4-bis(2-amino-2-methylpropyl)piperazine, and Jeffamine D230 and Jeffamine D400 each of which is manufactured by Mitsui Fine Chemicals, Inc. and has polypropylene glycol (PPG) as its backbone. Such polyamines as above may be used alone or in combination of two or more thereof.

In the present invention, from the viewpoint of imparting a certain flexibility to a cured product, a linear polyalkylene polyamine is more preferable. In this regard, from the viewpoint of obtaining a cured product which has a melting point of 50° C. or less and a boiling point of 100° C. or more and is, accordingly, easy to handle, a polyamine having amino groups at both ends of a linear alkylene having 3 to 6 carbon atoms is further preferable.

Specifically, among various polyamines as mentioned above for illustration, trimethylene diamine, tetramethylene diamine, pentamethylene diamine, and hexamethylene diamine are particularly preferred.

Ketimine compounds, which can be used in the composition of the present invention, include those obtained by combining various ketones and various amines as mentioned above.

Suitable examples of the ketimine compounds include: one obtained from diisobutyl ketone (DIBK) and tetrmethylene diamine (TMDA); one obtained from DIBK and hexamethylene diamine (HMDA); one obtained from ethyl (2-methylbutyl)ketone and HMDA; one obtained from DIBK and trimethylene diamine; one obtained from ethyl (2-methylbutyl)ketone and TMDA; one obtained from ethyl (2-methylbutyl)ketone and trimethylene diamine; and one obtained from DIBK and norbornane diamine.

The ketimine compound used in the composition of the present invention may be obtained by heating a ketone or aldehyde and an amine to reflux in the absence of a solvent or in the presence of such a solvent as benzene, toluene or xylene so as to react them with each other while removing the eliminated water in an azeotropic manner.

The ketimine compound is preferably contained in the composition of the present invention such that the equivalent ratio expressed as “(epoxy group in epoxy resin)/(ketimine bond in ketimine compound)” is 0.1 to 1.5, more preferably 0.3 to 1.2. In the combined use with a urethane prepolymer, the ketimine compound is preferably contained such that the equivalent ratio expressed as “(epoxy group in epoxy resin+isocyanate group in urethane prepolymer)/(ketimine bond in ketimine compound)” is 0.2 to 3.0, more preferably 0.5 to 2.0.

(Urethane Prepolymer)

The urethane prepolymer used in the composition of the present invention as needed is a reaction product obtained by reacting a polyol compound with an excess amount of polyisocyanate compound (i.e., excess isocyanate (NCO) groups with respect to the hydroxy (OH) groups).

The polyisocyanate compound from which the urethane prepolymer as described above is produced is not particularly limited as long as the polyisocyanate compound has 2 or more NCO groups in its molecule. Specific examples thereof include: aromatic polyisocyanates such as 2,4-tolylene diisocyanate (2,4-TDI), 2,6-tolylene diisocyanate (2,6-TDI), 4,4′-diphenylmethane diisocyanate (4,4′-MDI), 2,4′-diphenylmethane diisocyanate (2,4′-MDI), 1,4-phenylene diisocyanate, xylylene diisocyanate (XDI), tetramethylxylylene diisocyanate (TMXDI), tolidine diisocyanate (TODI), and 1,5-naphthalene diisocyanate (NDI); aliphatic polyisocyanates such as hexamethylene diisocyanate (HDI), trimethylhexamethylene diisocyanate (TMHDI), lysine diisocyanate, and norbornane diisocyanate methyl (NBDI); alicyclic polyisocyanates such as trans-cyclohexane-1,4-diisocyanate, isophorone diisocyanate (IPDI), hydrogenated XDI (H₆XDI), hydrogenated MDI (H₁₂MDI) and hydrogenated TDI (H₆TDI); polyisocyanate compounds such as polymethylene polyphenylene polyisocyanate; carbodiimide-modified polyisocyanates obtained from the above isocyanate compounds; isocyanurate-modified polyisocyanates obtained from the above isocyanate compounds; and urethane prepolymers obtained by reacting the above isocyanate compounds with the polyol compound as described below. Such polyisocyanate compounds as above may be used alone or in combination of two or more thereof.

Note that a monoisocyanate compound having only one NCO group in its molecule can also be used by mixing it with a diisocyanate compound or the like.

The polyol compound that gives the urethane prepolymer as described above is not particularly limited in molecular weight, backbone, and the like as far as the compound has two or more OH groups, and the specific examples thereof include low-molecular-weight polyhydric alcohols, polyether polyols, polyester polyols, other polyols, and mixtures of these polyols.

Specific examples of the low-molecular-weight polyhydric alcohols include: low-molecular-weight polyols such as ethylene glycol (EG), diethylene glycol, propylene glycol (PG), dipropylene glycol, (1,3- or 1,4-) butanediol, pentanediol, neopentyl glycol, hexanediol, cyclohexanedimethanol, glycerin, 1,1,1-trimethylolpropane (TMP), 1,2,5-hexanetriol, and pentaerythritol; and sugar alcohols such as sorbitol.

Next, for the polyether polyols and the polyester polyols, those derived from the low-molecular-weight polyhydric alcohols are generally used. In the present invention, those which are derived from the following aromatic diols, amines, and alkanolamines are also suitable to use.

Specific examples of the aromatic diols include: resorcin (i.e., m-dihydroxybenzene), xylylene glycol, 1,4-benzenedimethanol, styrene glycol, and 4,4′-dihydroxyethylphenol; and aromatic diols each having one of the bisphenol backbones of a bisphenol A structure (4,4′-dihydroxyphenylpropane), a bisphenol F structure (4,4′-dihydroxyphenylmethane), a brominated bisphenol A structure, a hydrogenated bisphenol A structure, a bisphenol S structure and a bisphenol AF structure as below.

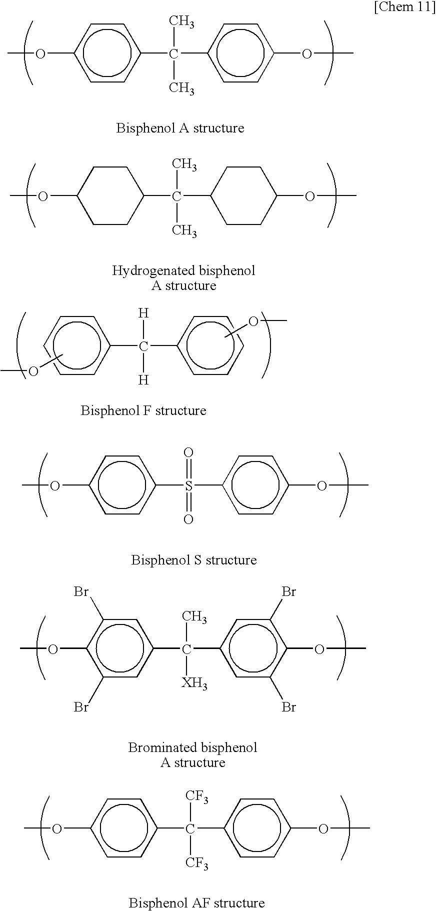

In addition, specific examples of the amines include ethylenediamine and hexamethylenediamine. Specific examples of the alkanolamines include ethanolamine and propanolamine.

An example of the polyether polyol is a polyol which is obtained by adding one selected from alkylene oxides such as ethylene oxide, propylene oxide, butylene oxide (tetramethylene oxide) and tetrahydrofuran as well as styrene oxides to any compound selected from the compounds as mentioned above as the low-molecular-weight polyhydric alcohols, the aromatic diols, the amines, and the alkanolamines.

Specific examples of the polyether polyol include polyethylene glycol, polypropylene glycol (PPG), polypropylene triol, an ethylene oxide/propylene oxide copolymer, polytetramethylene ether glycol (PTMEG), polytetraethylene glycol, and a sorbitol-based polyol.

Examples of the polyester polyol include: a condensate between any of the low-molecular-weight polyhydric alcohols, aromatic diols, amines and alkanolamines as above and a polybasic carboxylic acid (condensed polyester polyol); lactone-based polyols; and polycarbonate polyols.

Specific examples of the polybasic carboxylic acid which forms the condensed polyester polyol include glutaric acid, adipic acid, azelaic acid, fumaric acid, maleic acid, pimelic acid, suberic acid, sebacic acid, phthalic acid, terephthalic acid, isophthalic acid, dimer acids, pyromellitic acid, other low-molecular-weight carboxylic acids, oligomeric acids, and hydroxycarboxylic acids such as castor oil and a reaction product between castor oil and ethylene glycol (or propylene glycol).

Further, a specific example of the above-mentioned lactone-based polyols is the polyol having hydroxy groups at both ends, which is prepared by ring-opening polymerization of a lactone, such as ε-caprolactone, α-methyl-ε-caprolactone, or ε-methyl-ε-caprolactone, with an appropriate polymerization initiator.

Specific examples of other polyols include: acryl polyols; polybutadiene polyols; and polymer polyols each having a carbon-carbon bond in its backbone, such as a hydrogenated polybutadiene polyol.

In the present invention, various polyol compounds as mentioned above for illustration may be used alone or in combination of two or more thereof.

The urethane prepolymer used in the composition of the present invention as needed is, as described above, obtained by reacting a polyol compound with an excess amount of polyisocyanate compound. Specific examples of the urethane prepolymer include those obtained as various combinations of the above polyol compounds with the above polyisocyanate compounds.

In the present invention, the method of preparing the urethane prepolymer is not particularly limited. Specific examples of the method include a method of obtaining a urethane prepolymer by reacting a polyol compound with a polyisocyanate compound at a reaction temperature of 30 to 120° C., preferably 50 to 100° C., under normal pressure. Use of a urethanizing catalyst, such as an organotin compound or an organobismuth compound, is thinkable.

Further, in the present invention, in preparing the urethane prepolymer, the equivalent ratio (NCO/OH) of the NCO groups of a polyisocyanate compound to the OH groups of a polyol compound is preferably 1.2 to 5.0, and more preferably 1.5 to 3.0. When the ratio of NCO/OH is in this range, physical properties of the composition of the present invention after curing become favorable without foaming due to the remaining polyisocyanate compound and also without an increase in viscosity of the urethane prepolymer due to molecular-chain extension.

In the present invention, by using the urethane prepolymer as described above, the resulting moisture-curable resin composition has an appropriate viscosity (10 to 100 Pa·s at 23° C.), so the workability becomes more favorable.

In addition, in the present invention, even when the urethane prepolymer as described above is used, the resulting moisture-curable resin composition retains its good storage stability. As is evident from Examples and Comparative Examples described later, this is because the composition of the present invention contains the certain ketimine compound as described above. Specifically, the approach of not only an epoxy group of the above-mentioned epoxy resin but an NCO group of the urethane prepolymer to a nitrogen atom of the ketimine compound is considered as difficult owing to the effect of the steric hindrance brought about by the branching carbon atom which the ketimine compound has in either or both of the β positions with respect to the carbonyl carbon atom, and owing to the molecular movement of a bulky substituent including the branching carbon atom and smaller substituents bound thereto.

In the present invention, the above-mentioned urethane prepolymer preferably has the structure as represented by formula (9) below in which every NCO group in a molecule is bound to a secondary carbon atom or to a tertiary carbon atom which is not contained in an aromatic ring because the resulting moisture-curable resin composition of the present invention will have more favorable storage stability as well as favorable heat resistance and water resistance after curing.

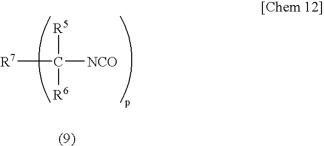

In the above formula (9), p represents an integer of 2 or more; and R⁵, R⁶, and R⁷ are each independently an organic group that may contain at least one hetero atom selected from the group consisting of O, N, and S, and R⁶ may be a hydrogen atom. In addition, a plurality of groups R⁵ may be the same or different, and a plurality of groups R⁶ may be the same or different. Further, when R⁶ is a hydrogen atom, R⁵ and the carbon atom to which R6 is bound may be bound together to form a ring.

Specific examples of the above-mentioned organic group include hydrocarbon groups such as an alkyl group, a cycloalkyl group, an aryl group, and alkylaryl group; and organic groups each containing a group having at least one hetero atom selected from the group consisting of O, N, and S (e.g., ether, carbonyl, amide, urea group (carbamido group), and urethane linkage). In this regard, each of the organic groups R⁵ and R⁶ is preferably an alkyl group, and a methyl group in particular.

The polyisocyanate compound from which the urethane prepolymer represented by the above-mentioned formula (9) is produced is suitably exemplified by TMXDI, IPDI, hydrogenated MDI, and hydrogenated TDI among various polyisocyanate compounds as mentioned above.

In the present invention, the content of the urethane prepolymer is 1 part by weight or more but less than 100 parts by weight, preferably 2 to 80 parts by weight, with respect to 100 parts by weight of the above-mentioned epoxy resin.

One of the preferred embodiments of the composition of the present invention contains a hydrolytic catalyst for the above-mentioned ketimine compound in view of workability control.

The hydrolytic catalyst to be used in the composition of the present invention as needed is not particularly limited. Specific examples thereof include carboxylic acids such as 2-ethylhexanoic acid and oleic acid; phosphoric acids such as polyphosphoric acid, ethyl acid phosphate, and butyl acid phosphate; and organic metals such as dibutyltin dilaurate and dioctyltin dilaurate.

In the present invention, the content of the hydrolytic catalyst is 0.01 to 20 parts by weight, preferably 0.1 to 10 parts by weight, with respect to 100 parts by weight of the above-mentioned ketimine compound.

One of the preferred embodiments of the composition of the present invention contains a silane coupling agent.

The silane coupling agent to be used in the composition of the present invention as needed is not particularly limited. Specific examples thereof include vinylsilane, epoxysilane, methacrylic silane, isocyanate silane, ketimine silane, mixtures or reaction products of these substances, and compounds obtained by reacting these substances with a polyisocynate.

Examples of the vinylsilane include vinyltrimethoxysilane, vinyltriethoxysilane, and tris-(2-methoxyethoxy)vinylsilane.

Examples of the epoxysilane include γ-glycidoxypropyltrimethoxysilane, γ-glycidoxypropyldimethylethoxysilane, γ-glycidoxypropylmethyldiethoxysilane, β-(3,4-epoxycyclohexyl)ethylmethyldimethoxysilane, γ-glycidoxypropyltrimethoxysilane, and β-(3,4-epoxycyclohexyl)ethyltrimethoxysilane.

Examples of the methacrylic silane include 3-methacryloxypropylmethyldimethoxysilane, 3-methacryloxypropyltrimethoxysilane, 3-methacryloxypropylmethyldiethoxysilane, and 3-methacryloxypropyltriethoxysilane.

Examples of the isocyanate silane include isocyanatepropyltriethoxysilane and isocyanatepropyltrimethoxysilane.

Examples of the ketimine silane include ketiminated propyltrimethoxysilane and ketiminated propyltriethoxysilane.

In the present invention, the content of the silane coupling agent as described above is preferably 0.1 to 10 parts by weight with respect to 100 parts by weight in total of the above-mentioned epoxy resin and the urethane prepolymer added as needed. If the content of the silane coupling agent is within this range, the composition of the present invention exhibits better adhesion properties when used as a sealing material.

If required, the composition of the present invention may contain various kinds of additives in addition to various components described above as far as the object of the present invention can be achieved. Examples of the additives include fillers, antiaging agents, antioxidants, antistatic agents, fire retardants, adhesion-providing agents, dispersants, and solvents.

Examples of the fillers include: agalmatolite clay, kaolin clay, and calcined clay; fumed silica, sintered silica, precipitated silica, silica flour, and fused silica; diatomaceous earth; iron oxide, zinc oxide, titanium oxide, barium oxide, and magnesium oxide; calcium carbonate, magnesium carbonate, and zinc carbonate; carbon black; and products obtained by treating these substances with a fatty acid, a resin acid, a fatty ester or a fatty ester urethane compound.

Examples of the antiaging agents include hindered phenol-based compounds and hindered amine-based compounds.

Examples of the antioxidants include butylhydroxytoluene (BHT) and butylhydroxyanisole (BHA).

Examples of the antistatic agents include quaternary ammonium salts, and hydrophilic compounds such as polyglycols and ethylene oxide derivatives.

Examples of the fire retardants include chloroalkyl phosphate, dimethyl methylphosphonate, bromine-phosphor compounds, ammonium polyphosphate, neopentylbromide-polyether, and brominated polyether.

Examples of the adhesion-providing agents include a terpene resin, a phenolic resin, a terpene-phenol resin, a rosin resin, a xylene resin, and an epoxy resin.

The above additives may be used appropriately in combination.

The method of producing the composition of the present invention from the components described above is not particularly limited, but may be one including the step of mixing the epoxy resin and ketimine compound as well as the optionally added urethane prepolymer and various additives as described above by a roll, a kneader, an extruder, a universal agitator, or the like.

The composition of the present invention is of a moisture-cured type and may be used as a one-component type composition. If required, the composition of the present invention may also be used as a two-component type composition, with the epoxy resin being included in the principal agent (component A) and the ketimine compound in the curing agent (component B).

When the composition of the present invention is exposed to moisture, a curing reaction proceeds owing to the amine compound generated by hydrolysis of the ketimine compound, so that it is also possible to allow the curing reaction to proceed by an appropriate supply of water to the composition.

The composition of the present invention, as having the characteristics as described above, can be used for a sealing material for a building, which is applied between outer wall panels or between the sash and the glass of a window; a structural adhesive for concrete or mortar; a sealer with which cracks are filled in; and the like.

### EXAMPLES

The present invention will be described in more detail with reference to the following Examples. However, the present invention is not limited to those Examples.

(Epoxy Resin A)

The epoxy resin A used was ADEKA RESIN EP4100E (available from ADEKA CORPORATION, and having an epoxy equivalent of 190) which is a general-purpose, bisphenol A-based epoxy resin.

(Urethane Prepolymer A)

The urethane prepolymer A used was the urethane prepolymer (isocyanate group content: 3.5% by weight) which had been obtained by mixing a bifunctional PPG (Excenol 2020, available from Asahi Glass, Co., Ltd.) having a number-average molecular weight of 2,000 and tetramethyl xylylene diisocyanate (TMXDI, available from Nihon Cytec Industries Inc.) at an equivalent ratio of isocyanate group/hydroxy group (the number of isocyanate groups per hydroxy group) (hereinafter, simply referred to as “NCO/OH”) of 2.0, and allowing them to react together in the presence of a tin catalyst under a nitrogen gas stream at 80° C. for 8 hours.

(Ketimine Compound A)

The ketimine compound A used was the ketimine compound which had been synthesized by adding tetramethylene diamine (TMDA) and diisobutyl ketone (DIBK) represented by the above-mentioned formula (8) to a flask at a molar ratio of 1:4, accompanied by toluene used as an azeotropic solvent, and allowing them to react together at 160° C. for 20 hours while removing the generated water in an azeotropic manner.

(Ketimine Compound B)

The ketimine compound B used was synthesized in a similar manner as the ketimine compound A except that hexamethylene diamine (HMDA) was used instead of tetramethylene diamine (TMDA).

(Ketimine Compound C)

The ketimine compound C used was synthesized in a similar manner as the ketimine compound B except that ethyl (2-methylbutyl)ketone represented by the above-mentioned formula (7) was used instead of diisobutyl ketone (DIBK).

(Ketimine Compound D)

The ketimine compound D used was synthesized in a similar manner as the ketimine compound B except that methyl isobutyl ketone (MIBK) was used instead of diisobutyl ketone (DIBK).

(Ketimine Compound E)

The ketimine compound E used was synthesized in a similar manner as the ketimine compound B except that di(n-butyl)ketone was used instead of diisobutyl ketone (DIBK).

(Ketimine Compound F)

The ketimine compound F used was synthesized in a similar manner as the ketimine compound A except that norbornane diamine (NBDA) was used instead of tetramethylene diamine (TMDA).

(Calcium Carbonate)

The calcium carbonate used was precipitated calcium carbonate (Viscolite MBP, available from Shiraishi Calcium Kaisha, Ltd.).

(Vinylsilane)

The vinylsilane used was vinyl trimethoxy silane (KBM-1003, available from Shin-Etsu Chemical Co., Ltd.). Examples 1 to 7, and Comparative Examples 1 to 3

Compositions were prepared by mixing the components described above at component ratios (parts by weight) shown in Table 1 below. Each of the resulting compositions was evaluated on the workability and storage stability as described below. The results are shown in Table 1 below.

(Workability)

For evaluating the workability, the working life of each composition obtained was examined.

The working life (hours) was measured at a temperature of 30° C. as the period of time starting immediately after preparation of the relevant composition and terminating when the surface of the cured product has lost the tackiness.

The workability can be considered as excellent when the working life is 3 to 4 hours.

(Storage Stability)

For the evaluation of storage stability, the ratio between the viscosities of each composition after storage and immediately after preparation (i.e., viscosity increase rate of the composition) was examined.

The viscosity increase rate (expressed by a numeral with the suffix “-fold”) of each composition was found by measuring the viscosities (Pa·s) of the relevant composition at 23° C. immediately after preparation and after storage at 30° C. for one month using a BS-type viscometer (No. 7 rotor) with a rotation speed of 10 rpm, and calculating the ratio of “(viscosity after storage at 30° C. for one month)/(viscosity immediately after preparation)”.

The storage stability can be considered as excellent when the viscosity increase rate is less than twofold.

TABLE 1

| | Comparative | | | | | | | | | |
|---|---|---|---|---|---|---|---|---|---|---|
| | Example | | | Example | | | | | | |
| | 1 | 2 | 3 | 1 | 2 | 3 | 4 | 5 | 6 | 7 |
| Epoxy resin A | 100 | 100 | 100 | 100 | 100 | 100 | 100 | 100 | 100 | 100 |
| Urethane prepolymer A | | | 40 | | | | 2 | 40 | 80 | 40 |
| Ketimine compound A | | | | 31 | | | | | | |
| Ketimine compound B | | | | | 35 | | 35 | 41 | 47 | |
| Ketimine compound C | | | | | | 33 | | | | |
| Ketimine compound D | 33 | | | | | | | | | |
| Ketimine compound E | | 35 | 41 | | | | | | | |
| Ketimine compound F | | | | | | | | | | 48 |
| Calcium carbonate | 100 | 100 | 100 | 100 | 100 | 100 | 100 | 100 | 100 | 100 |
| Vinylsilane | 5 | 5 | 5 | 5 | 5 | 5 | 5 | 5 | 5 | 5 |
| Viscosity increase | >5- | <2- | >4- | <2- | <2- | <2- | <2- | <2- | <2- | <2- |
| rate | fold | fold | fold | fold | fold | fold | fold | fold | fold | fold |
| Working life (hours) | 1.5 | <1.0 | <0.5 | 3.0 | 4.0 | 3.0 | 4.0 | 3.5 | 3.0 | 3.0 |

As seen from the results shown in Table 1, the compositions of Examples 1 to 7 were each excellent in workability and storage stability compared with any of the compositions of Comparative Examples 1 to 3.

1. A moisture-curable resin composition, comprising:
an epoxy resin; and
a ketimine compound having a ketimine (C═N) bond which is derived from a ketone represented by formula (1) below, 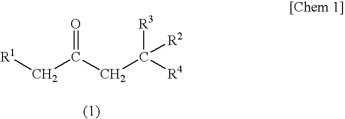
[where R¹ represents an alkyl group which has 1 to 5 carbon atoms and may have a substituent; R² represents an alkyl group having 1 to 4 carbon atoms; and R³ and R⁴ each independently represent an alkyl group having 1 to 3 carbon atoms, and either of them may represent a hydrogen atom], and an amine.

2. The moisture-curable resin composition according to claim 1, wherein said ketone is a ketone represented by formula (2) below: 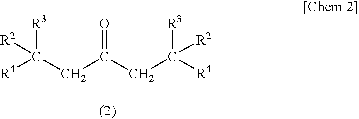
[where R² represents an alkyl group having 1 to 4 carbon atoms, with a plurality of groups R² being maybe the same or different; and R³ and R⁴ each independently represent an alkyl group having 1 to 3 carbon atoms, and either of them may represent a hydrogen atom, with a plurality of groups R³ being maybe the same or different, and a plurality of groups R⁴ being maybe the same or different].

3. The moisture-curable resin composition according to claim 1, wherein said amine is a polyamine having at least two amino groups in a molecule.

4. The moisture-curable resin composition according to claim 3, wherein said polyamine is a linear polyalkylene polyamine.

5. The moisture-curable resin composition according to claim 4, wherein said polyamine has amino groups at both ends of a linear alkylene having 3 to 6 carbon atoms.

6. The moisture-curable resin composition according to claim 1, further comprising 1 part by weight or more but less than 100 parts by weight of a urethane prepolymer with respect to 100 parts by weight of said epoxy resin.

7. The moisture-curable resin composition according to claim 6, wherein said urethane prepolymer has a structure in which every isocyanate group in a molecule binds to a secondary carbon atom, or to a tertiary carbon atom other than that in an aromatic ring.
